(19) United States
(12) Patent Application Publication
(10) Pub. No.: US 2007/0005559 A1
(43) Pub. Date: Jan. 4, 2007

(54) User customization of default data

(75) Inventors: Kevin M. Magarian, Fargo, ND (US); Kimberly A. Nelson, Fargo, ND (US); Ronald H. Schulz, West Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/173,306

(22) Filed: Jul. 1, 2005

(51) Int. Cl. G06F 17/30

(52) U.S. Cl. 707/1

(57) ABSTRACT

A computer-implemented method is provided for defining criteria for use in defaulting data in a transaction for an ERP system. The computer-implemented method includes providing a plurality of data entities that are available for defaulting in the ERP system. The computer-implemented method also includes selecting a select number of data entities from the plurality of data entities based on a user input. The select number of data entities are available as criteria for defaulting data in transactions.

### BACKGROUND

Enterprise resource planning (or ERP) is a phrase used to describe a broad set of activities supported by multi-module application software that helps a company manage the important parts of its business. Computerized ERP systems typically handle the logistics of various activity modules internal to a business or organization, such as accounting/financial management, customer relations management, supply chain management and human resource management. Often, an ERP system uses or is integrated with a relational database system. Examples of ERP system software packages include Microsoft® Business Solutions Axapta®, Navision® and Great Plains®.

ERP systems utilize a large number of files that are part of a collection of information that is stored in a database shared by the various management application modules. These files represent widely varying types of information, for example including information related to transactions such as sales, purchase orders and bill payments and information related to reference data, such as currencies, exchange rates, and customer profiles, as well as ledgers and other accounting tables.

There are a large number of events in which users create a new instance of a transaction in the course of conducting daily business activities. For example, creating new purchase orders, invoices and expense reports. To create a new instance of a transaction, the user opens a data entry screen and enters new data into the data entry screen.

When the data entry screen is initially displayed to the user, it is common practice for initial default data to be entered into some of the data fields after data is entered into a controlling data field of the data entry screen. For example, when an order entry clerk enters a new order from a customer, and after a customer number is entered in a controlling field, the data entry screen can display default data such as billing address, shipping address, method of payment, method of shipment and other fixed data associated with the manually entered customer number.

In general, ERP systems often limit the user to a predefined list of data stored in the commonly shared database that can be used as criteria data for defaults. By limiting the user to a predefined list, many times default data that is automatically inserted into a transaction is the wrong data. In the example above, the order entry clerk is limited to the criterion of a customer number.

Upon entering the customer number, all the default data is automatically inserted. However, for this particular customer, the item being ordered needs special pricing. The order entry clerk must then go in and manually change the customer/item pricing. Such manual data entry and manual data selection are time-consuming, costly and prone to errors.

### SUMMARY

This Summary is provided to introduce a selection of concepts in a simplified form that are further described below in the Detailed Description.

This Summary is not intended to identify key features or essential features of the claimed subject matter, nor is it intended to be used as an aid in determining the scope of the claimed subject matter.

Criteria for use in defaulting data in a transaction for an ERP system can be defined using several steps. The data entities that are available in the ERP system are provided. Then, a select number of data entities are selected from the provided data entities based on a user input. The select number of data entities are available as criteria for defaulting data in transactions.

An ERP system includes a database. The database includes a plurality of data entities selectable by a user. The data entities selected by the user include default data entities. The ERP system also includes a defaulting system. The defaulting system is configured to access the plurality of default data entities to develop default rules for populating default fields in a transaction.

### BRIEF DESCRIPTION OF THE DRAWINGS

FIG. 1 is a block diagram of a general computing environment in which disclosed concepts can be practiced.

FIG. 2 is a block diagram illustrating an Enterprise Resource Planning system (ERP).

FIG. 3 is a block diagram illustrating a database of an ERP system.

FIG. 4 is a block diagram illustrating a database of an ERP system.

FIG. 5 is a flowchart illustrating a method for defining criteria for use in defaulting data.

FIG. 6 is a flowchart illustrating a method for defaulting data in a transaction.

### DETAILED DESCRIPTION

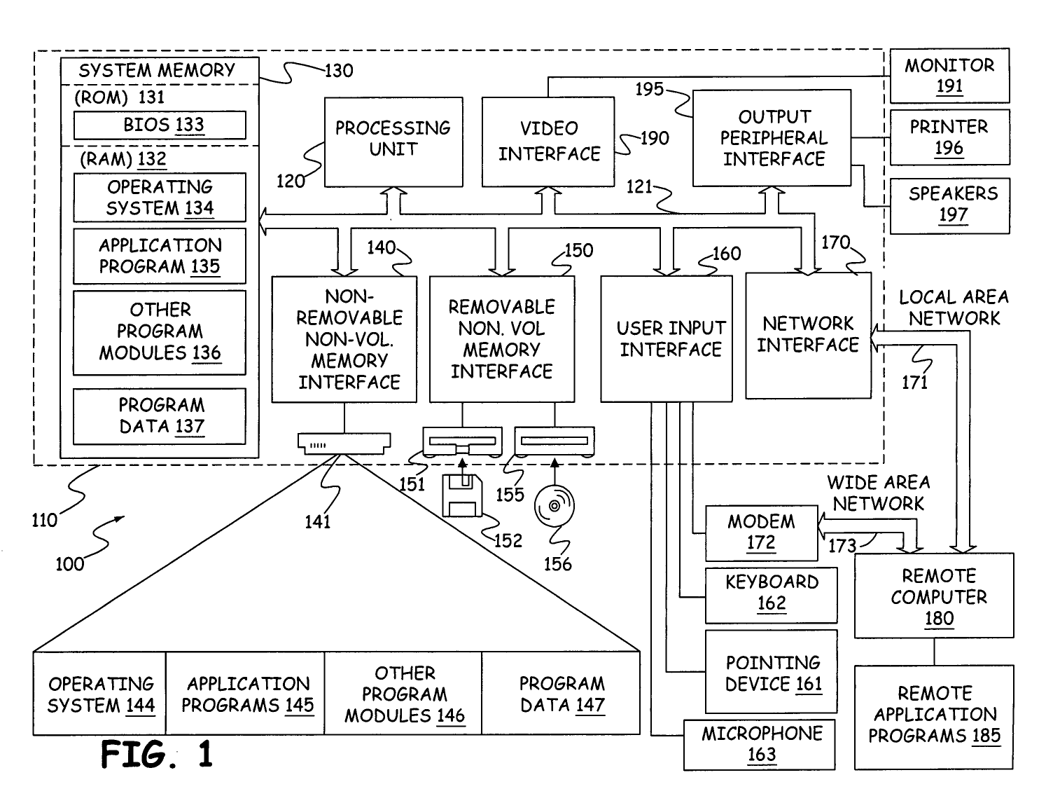

The following description is described in the context of an Enterprise Resource Planning (ERP) system. Processes in the ERP system are performed in the form of transactions or documents. A transaction can be defined as an event or conduction of business that occurs between two parties, such as between a customer and a supplier. A transaction can also be an event that occurs internal to the accounting system, such as adjustments to a general ledger or depreciation. For example, a transaction can be entered in a data entry form and recorded on a document to include data describing the event and data describing how a particular transaction should behave. Before describing aspects of the illustrated embodiments, however, it may be useful to describe suitable computing environments that can incorporate and benefit from these aspects. ERP systems are typically implemented in a networked environment of server computers and/or other computers. The computing environment shown in FIG. 1 is one such example.

FIG. 1 illustrates an example of a suitable computing system environment 100 on which one or more aspects of the illustrated embodiments may be implemented. The computing system environment 100 is only one example of a suitable computing environment and is not intended to suggest any limitation as to the scope of use or functionality of the illustrated embodiments. Neither should the computing environment 100 be interpreted as having any dependency or requirement relating to any one or combination of components illustrated in the exemplary operating environment 100.

The illustrated embodiments are operational with numerous other general purpose or special purpose computing system environments or configurations. Examples of well-known computing systems, environments, and/or configurations that may be suitable for use with the illustrated embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The illustrated embodiments may be described in the general context of computer-executable instructions, such as program modules, being executed by a computer. Generally, program modules include routines, programs, objects, components, data structures, etc. that perform particular tasks or implement particular abstract data types. The illustrated embodiments may also be practiced in distributed computing environments where tasks are performed by remote processing devices that are linked through a communication network. In a distributed computing environment, program modules may be located in both local and remote computer storage media including memory storage devices. Tasks performed by the programs and modules are described below and with the aid of figures. Those skilled in the art can implement the description and figures provided herein as processor executable instructions, which can be written on any form of a computer readable medium.

With reference to FIG. 1, an exemplary system includes a general-purpose computing device in the form of a computer 110. Components of computer 110 may include, but are not limited to, a processing unit 120, a system memory 130, and a system bus 121 that couples various system components including the system memory to the processing unit. System bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, Intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

ERP systems commonly use entity relationship databases for modeling data, such as entity relationship databases that use UML (unified modeling language). An entity is a relational database data structure which manages data. The entity preserves its internal data and the integrity of its relationship with other entities. In the ERP system that corresponds with the illustrated embodiments, entities are commonly referred to as data entities.

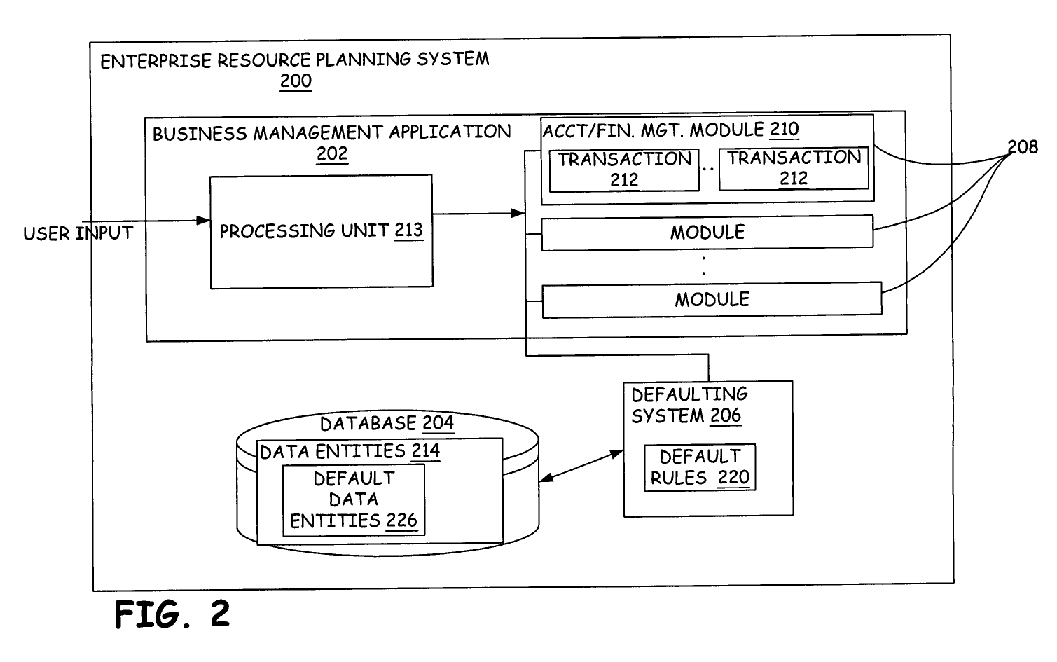

FIG. 2 is a block diagram illustrating an Enterprise Resource Planning system (ERP) 200. ERP system 200 includes a business management application 202, a database 204 and a defaulting system 206. Business management application 202 includes a plurality of modules 208. Each module 208 is a management application that includes a plurality of transactions 212. As illustrated in FIG. 2, an example module includes an accounting/financial management module 210. Other example modules include customer relation management, supply chain management and human resource management. Each transaction 212 documents an event or conduction of business that occurs specific to the module of which it belongs. The example accounting/financial management module 210 includes transactions 212 specific to accounting and finance. For example, some of the transactions 212 that exist within module 210 include accounts payable transactions, such as invoices and returns.

Business management application 202 also includes a processing unit 213. Processing unit 213 is configured to receive an input from a user. Processing unit 213 is also configured to communicate with both database 204 and defaulting system 206. Information in database 204 is made available to a user. In turn, processing unit 213 allows a user to select data from the available information in database 204. In one embodiment, information is made available to a user by displaying the information on a display screen.

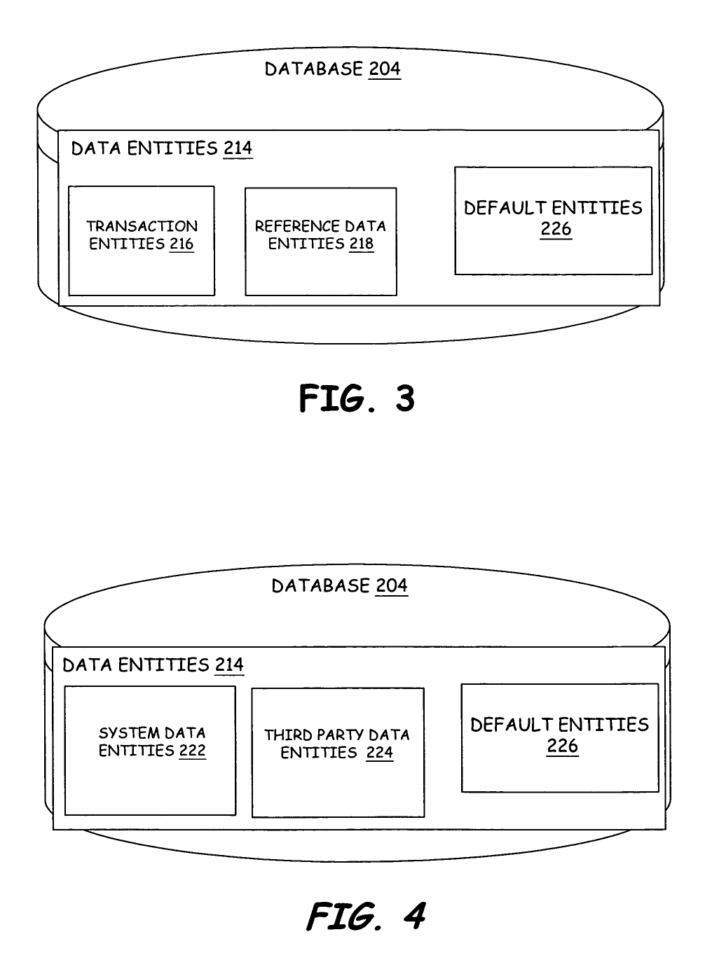

FIG. 3 is a more detailed block diagram of database 204. In FIG. 3, database 204 stores a plurality of data entities 214. Data entities 214 can be transaction type entities 216 or reference data type entities 218. Transaction type entities 216 include information about specific transactions. For example, data entities in database 204 can store information related to an invoice transaction. Making such information available allows a user to default data in the invoice transaction when the user enters in a return transaction. Reference data type entities 218 include information that is inserted into a transaction and is transacted against. Example reference data type entities include shipping addresses, billing addresses, account numbers, currencies and etc.

FIG. 4 is a more detailed block diagram of database 204. In FIG. 4, data entities 214 include system data entities 222 and third party data entities 224. System data entities 222 are those data entities that are preexisting data entities in the ERP system. In general, system data entities 222 are those data entities that were inserted into database 204 when ERP system 200 was developed. Third party data entities 224 are those data entities that are inserted into database 204 by a third party. This feature allows a third party, such as a client of the ERP system, to make their own data entities available in the system.

Referring back to FIG. 2, defaulting system 206 includes default rules 220. Generally, defaulting systems, such as defaulting system 206, is configured to use default rules, such as default rules 220, to assign data fields in a transaction as default fields based on at least one criterion. These default fields are automatically populated with data based on the at least one manually entered criterion or data field.

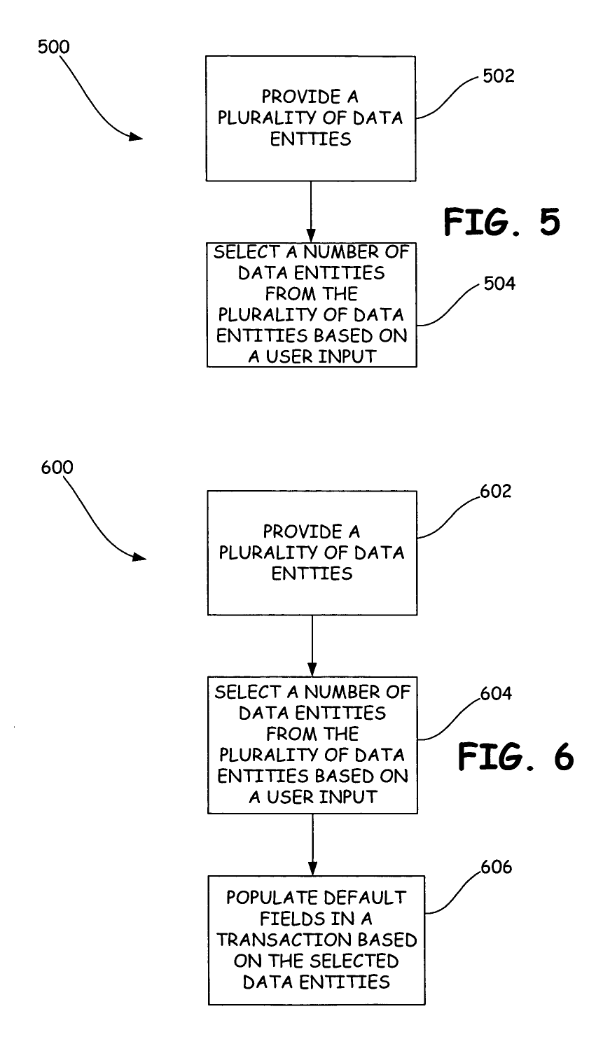

FIG. 5 is a flowchart 500 illustrating a method of defining criteria for use in defaulting data in transactions. At block 502, a plurality of data entities are provided. These data entities are those illustrated in FIGS. 2, 3 and 4 as data entities 214. In general, data entities 214 are provided or are available to a user for selection provided they meet the criteria for use as a default entity as provided by the development environment. For example, the following data entities are available for selection by a user in ERP system 200:

| | |
|---|---|
| Accounts | Dimensions |
| Dimension Codes | Users |
| Customers | Territories |
| Items | Sites |
| Suppliers | Currencies |
| Exchange Rates | General Journal Transactions |
| Accounts Receivable Sales Trans. | Accounts Payable Transactions |
| Cash Receipt Transactions | Payment Transactions |

The data entities of accounts, dimensions, dimension codes, users, customers, territories, items, sites suppliers, currencies and exchange rates are reference data type entities. The data entities of general journal transactions, accounts receivable sales transactions, accounts payable transactions, cash receipt transactions and payment transactions are transaction type entities. Many of the above data entities are those entities that are system data entities. However, some of the above data entities are third party data entities. For example, the data entity titled users is a third party data entity that a third party has made available to a user for selection.

At block 504, a select number of data entities are selected from the plurality of data entities based on a user input that meet the defined criteria for use as default data entities. In general, the user selects which of the available data entities they would like to select or customize as criteria for defaulting data in transactions. The criteria the user selects depends on many different factors. However, in general, the user desires to select criteria that provides better usability in defining default rules 220 in defaulting system 206 and also coincides with the user's business needs. For example, a user may select the following data entities for use in defaulting data:

| | |
|---|---|
| Dimensions | Dimension Codes |
| Customers | Territories |
| Items | Sites |
| Suppliers | |

These select number of data entities are selected for use in defaulting data and are collectively called default data entities 226. Default data entities 226 contain a much more manageable list of criteria for developing default rules 220 in defaulting system 206. In addition, when developing default rules 220 using the default data entities 226, a user will not mistakenly select a data entity that is invalid for use in defaulting data.

FIG. 6 is a flowchart illustrating a method of defaulting data in a transaction. At block 602, a plurality of data entities are provided. These data entities are those illustrated in FIGS. 2, 3 and 4 as data entities 214. In general, data entities 214 are provided and are available to a user for selection. The step illustrated in block 602 corresponds with the step illustrated in block 502 of FIG. 5. At block 604, a select number of data entities are selected from the plurality of data entities based on a user input. In general, the user selects which of the available data entities they would like to select as criteria for defaulting data in transactions. The step illustrated in block 604 corresponds with the step illustrated in block 504 of FIG. 5. At block 606, default fields in a transaction are populated based on the selected data entities. The default fields in the transaction are populated using defaulting system 206 which operates in accordance with default rules 220. Using the example discussed in FIG. 5, defaulting system 206 uses the selected data entities (dimensions, dimension codes, customers, territories, items, sites, suppliers) as criteria for defaulting data. For example, default rules 220 can use the data entities of customers and items to populate default fields in a transaction, such as shipping address, billing address and account number. In another example, default rules 220 can use the data entities of dimensions and dimension codes to populate the default field of salesperson. Dimensions include additional information in a transaction, such as department, location and sales territory. Dimension codes are the codes for each dimension. For example, the sales territory dimension can include northeast, southeast, southwest and northwest dimension codes. Therefore, the default rules 220 can use the sales territory dimension and the dimension code northeast to automatically populate a default field in a transaction for a particular salesperson. The particular salesperson is associated with the particular sales territory criteria.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for defining criteria for use in defaulting data in transactions for an ERP system, the computer-implemented method comprising:
providing a plurality of data entities that are available in the ERP system;
and
selecting a select number of data entities from the plurality of data entities based on a user input, wherein the select number of data entities are available as criteria for defaulting data in transactions.

2. The computer-implemented method of claim 1, wherein the select number of data entities form default data entities.

3. The computer-implemented method of claim 2, further comprising defaulting data using a defaulting system based on the criteria defined by the default data entities.

4. The computer-implemented method of claim 3, wherein the defaulting system develops default rules based on the criteria defined by the default entities.

5. The computer-implemented method of claim 1, wherein providing the plurality of data entities comprises providing all data entities that exist in the ERP system.

6. The computer-implemented method of claim 1, wherein providing the plurality of data entities comprises providing data entities added to the ERP system by a third party.

7. The computer-implemented method of claim 1, wherein providing the plurality of data entities comprises providing all data entities that exist in the ERP system and providing data entities added to the ERP system by a third party.

8. The computer-implemented method of claim 1, wherein the data entities comprise transaction entities and reference data entities, wherein the transaction entities correspond with transactions stored in the ERP system and the reference data entities include data in the transactions used to transact against.

9. A system for use in performing transactions, the system comprising:
a database having a plurality of default data entities selectable by the user from a plurality of data entities that meet defaulting criteria; and
a defaulting system configured to access the plurality of default data entities to develop default rules for populating select default fields in the transactions.

10. The system of claim 9, wherein the plurality of data entities comprise all data entities that exist in the database.

11. The system of claim 9, wherein the plurality of data entities comprise data entities added to the database by a third party.

12. The system of claim 9, wherein the plurality of data entities comprise all data entities that exist in the database and data entities added to the database by a third party.

13. The system of claim 9, wherein the plurality of data entities comprises transaction entities and reference data entities, wherein the transaction entities correspond with transactions stored in the ERP system and the reference data entities include data in the transactions used to transact against.

14. A computer-readable medium having computer executable instructions for performing a method comprising:
providing a plurality of data entities;
selecting a select number of data entities from the plurality of data entities based on a user input, wherein the select number of data entities are available as criteria for defaulting data in transactions; and
populating default fields in a transaction based on the select number of data entities.

15. The computer-readable medium of claim 1, wherein the select number of data entities form default data entities.

16. The computer-readable medium of claim 15, wherein the data fields in the transaction are automatically populated using a defaulting system.

17. The computer-readable medium of claim 16, wherein the defaulting system develops default rules based on the criteria defined by the default data entities.

18. The computer-readable medium of claim 14, wherein providing the plurality of data entities comprises providing all data entities that exist in the computer-readable medium.

19. The computer readable medium of claim 14, wherein providing the plurality of data entities comprises providing data entities added to the computer-readable medium by a third party.

20. The computer readable medium of claim 14, wherein providing the plurality of data entities comprises providing all data entities that exist in the computer-readable medium and providing data entities added to the comptuer-readable medium by a third party.
